(19) United States
(12) Patent Application Publication
(10) Pub. No.: US 2026/0036191 A1
(43) Pub. Date: Feb. 5, 2026

(54) BARREL CAM ACTUATOR WITH STRAIN WAVE GEARING DEVICE

(71) Applicant: DANA ITALIA S.R.L., Arco (IT)

(72) Inventors: Pier Paolo RINALDI, Arco (IT); Mark SLATER, Warwickshire (GB); Giuseppe MANICA, Isera (IT); Valentina GIULIANI, Arco (IT)

(21) Appl. No.: 18/788,760

(22) Filed: Jul. 30, 2024

(51) Int. Cl. F16H 37/12; F16H 63/30

(52) U.S. Cl. CPC F16H 37/124; F16H 63/304; F16H 2063/3056

(57) ABSTRACT

Systems and methods for a barrel cam actuator assembly. The barrel cam actuator assembly includes, in one example, a barrel cam including a first track and a strain wave gearing device that is arranged coaxial to the barrel cam and rotationally coupled to the barrel cam. The barrel cam actuator assembly further includes an electric motor rotationally coupled to the strain wave gearing device and configured to selectively rotate the strain wave gearing device. Further, in the barrel cam actuator assembly, the strain wave gearing device includes an outer spline, a flexible inner spline that meshes with the outer spline, and an elliptical wave generator.

### TECHNICAL FIELD

The present description relates to a compact barrel cam actuator.

### BACKGROUND AND SUMMARY

Some vehicles and other types of equipment include transmissions that provide speed-torque conversions with regard to mechanical power generated by a prime mover such as an engine or motor and transferred to drive wheels. Certain transmissions include clutches that facilitate shifts between discrete gear ratios. Shift forks have been used to engage and disengage clutches, such as dog clutches.

In some transmissions, barrel cam actuators are used due to their ability to efficiently provide smooth and controlled movement of a gear shift mechanism. Barrel cam actuators additionally exhibit higher reliability and are able to withstand higher levels of stress and wear when compared to other types of actuators, in some cases. These barrel cam actuator characteristics may make them particularly suitable for higher performance vehicles and industrial machinery, for instance. Although barrel cams may be deployed in a wide variety of transmissions and vehicles such as manual and automatic transmissions as well as all-electric vehicles and hybrid electric vehicles (HEVs).

The inventors have recognized that barrel cam actuators may exhibit greater complexity than other actuation systems and gear reductions in the actuators may undesirably increase the space inefficiency of the actuation systems. The inventors have also recognized that certain barrel cam actuators may exhibit constrained range of motion due to the shape of the cam which may make the barrel cam actuator undesirable for certain applications, in some instances. To elaborate, during shifting transients, clutches may experience a condition where the clutch faces are arranged such that they impede the engagement stroke. This condition is referred to as a blocked condition. The blocked condition increases the chance of actuation system degradation. For instance, clutch actuators that utilize electric motors may stall the motor due to the clutch binding, in certain scenarios, due to the actuation system being unable to exhibit enough compliance to reduce the chance (e.g., avoid) of the clutch exhibiting a block condition during engagement. Motor stall may degrade the actuation motor and/or its power electronics. Further, even if degradation does not occur due to actuator stall, the actuator starts from zero speed, thereby delaying clutch engagement or missing clutch engagement, entirely, in some scenarios. As such, the inventors have recognized a desire to increase compliance in clutch actuators to reduce the likelihood of clutch binding. However, the inventors have recognized that tradeoffs may exist between actuation system compliance and clutch performance and functionality.

The inventors have recognized the abovementioned challenges and developed a barrel cam actuator assembly. The barrel cam actuator assembly include, in one example, a barrel cam including a first track and a strain wave gearing device that is arranged coaxial to the barrel cam and rotationally coupled to the barrel cam. The barrel cam actuator assembly further includes an electric motor rotationally coupled to the strain wave gearing device and configured to selectively rotate the strain wave gearing device. Further, the strain wave gearing device includes an outer spline, a flexible inner spline that meshes with the outer spline, and an elliptical wave generator. In this way, a space efficient barrel cam actuator is achieved which applies a desired amount of torque to the barrel cam for clutch actuation.

In one example, the barrel cam includes a second track. In such an example, the first track and the second track include a section that axially extends along a periphery of the barrel cam. In this way, the barrel cam actuator assembly may be efficiently inserted as a cartridge. Consequently, efficiency with regard to transmission assembly, servicing, and repair is increased.

Further, in one example, the barrel cam may include a hollow interior section and at least a portion of the flexible inner spline of the strain wave gearing device may be positioned within the hollow interior section. In this way, the barrel cam actuator assembly's space efficiency is further increased, thereby enabling the assembly to be more easily packaged in a wider variety of transmissions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle system with a transmission.

FIG. 2 shows an example of a barrel cam actuator assembly.

FIG. 3 shows another example of a barrel cam actuator assembly.

FIG. 4 shows yet another example of a barrel cam actuator assembly with a strain wave gearing device.

FIGS. 5-6 show detailed view of the strain wave gearing device.

FIGS. 7A-7B show another example of a barrel cam actuator assembly.

FIGS. 8A-9 show an example of a barrel cam actuator assembly with axial elasticity.

FIGS. 10A-10C show an example of a dog clutch.

FIG. 11 shows another example of a dog clutch.

FIG. 12 shows another example of a barrel cam actuator assembly.

FIG. 13 shows an illustration of an exemplary barrel cam tracks.

### DETAILED DESCRIPTION

Dog clutches and synchronizers are used in some transmissions to engage and disengage gears. These clutches include two interlocking pieces which mate with one another to engage gears. As such, in one example, when the clutch is engaged, the mating surfaces are locked together, allowing the gear to rotate with the shaft. When the clutch is disengaged, the mating surfaces are separated, allowing the gear to rotate freely. Dog clutches may generally exhibit lower power losses than other types of clutches such as friction clutches, for instance. To expound, dog clutches and synchronizers may not experience drag torque that arises from viscous friction of the oil trapped in the clearance between the sliding surfaces of the wet friction clutch. Dog clutches and synchronizers may additionally have fewer components and experience greater reliability than friction clutches, in some cases. Further, in electric powertrains, the performance of the traction motor may enable the number of gear ratios in the transmission to be reduced. However, this may lead to higher speed gaps at the clutches which may not be attainable by some friction clutches. Due to a residual small differential speed between the two elements of the clutch, the desirable condition to engage is intermittent, with time windows where the engagement is possible followed by time windows where it is impeded. The time windows length depends on differential speed and dog clutch design. At lower differential speeds, the gearshift may be less abrupt, but the time windows will be longer so the exposure to face-to-face event and the time to recover may also be increased. There may also be a theoretical condition of a null differential speed and infinite time window. In electric vehicle applications, the differential speed can be commanded to a target value by a control logic that uses the traction motor. When the engagement condition is verified, a lowest force is demanded to complete the engagement. If the condition is not guaranteed, during the engagement stroke the teeth of both parts will stop in a face-to-face match thus impeding the engagement and causing the actuation motor to stall. When the actuator in the actuator assembly is an electric motor, motor stalling may occur during a face to face clutch conditions also referred to as a blocked condition. In previous actuation systems, the electric motor stall can lead to different issues that span from overcurrent to degraded dynamic response. The overcurrent may degrade the electric motor and/or its power electronic, in some instances. Even if component degradation in the actuation system does not occur, the motor starts from zero speed again to engage, and this delay may result in missing the favorable time window, grinding noise, and/or not completing the engagement.

The following description relates to a barrel cam actuator assembly for a transmission of a vehicle. One aspect of the barrel cam actuator assembly is designed with a space efficient gear reduction between an electric motor and the barrel cam. To elaborate, a strain wave gearing device is provided between the motor and the barrel cam to provide a comparatively high gear reduction (e.g., a gear ratio equal to or greater than 50:1, in one specific example) in a space efficient package. Further, due to the increased compactness achieved by the barrel cam assembly the barrel cam may be designed with multiple tracks that include axially extending sections (e.g., sections that are parallel to the barrel cam's central axis) which allow the barrel cam actuator assembly to be inserted into a transmission as a cartridge, thereby increasing efficiency with regard to transmission manufacturing, manufacturing, servicing, and repair.

Another aspect of the barrel cam actuator assembly is designed with axial elasticity that allows the assembly to effectively store energy during a blocked condition of a clutch, for example. To elaborate, the mechanical elasticity of the actuator assembly may allow for the accumulation of the energy generated by an actuation motor or other suitable actuator, thereby reducing the chance of the motor stalling. When the blocking condition is removed (e.g., and the desired teeth positions is verified) the actuator assembly faces less resistance and the accumulated energy is released, completing the engagement. In this way, the likelihood of actuation motor stalling is reduced and the clutch can be quickly engaged after the blocked condition is discontinued. Further, this quick clutch engagement and reduced likelihood of motor stall may be achieved without any additional control features, if so desired.

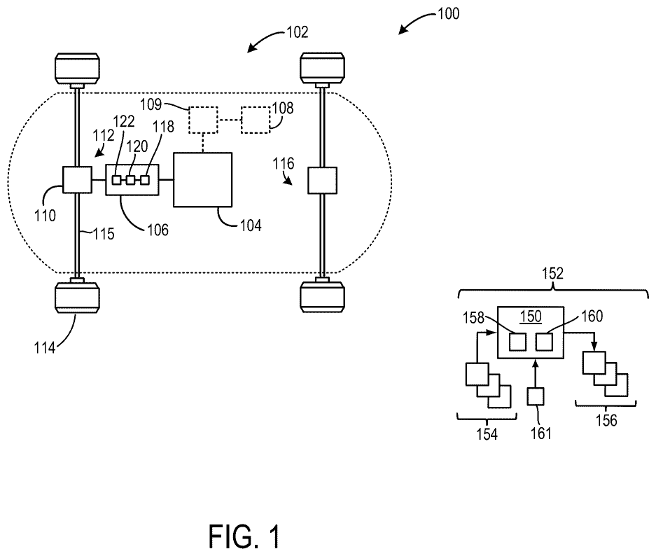

FIG. 1 shows a schematic depiction of a vehicle 100 with a powertrain 102 (e.g., an electric powertrain) that may include a prime mover 104 and a transmission 106. In some examples, the prime mover 104 may be an electric motor (e.g., a traction motor). In such an example, the electric motor may be electrically connected to an energy storage device 108 (e.g., one or more traction batteries, capacitors, fuel cells, combinations thereof, and the like). Further, in the electric motor example, the motor may be configured to operate as a generator, during selected conditions, to provide electrical power to charge the energy storage device 108, for example. In other examples, the prime mover 104 may be an internal combustion engine. Therefore, the vehicle 100 may be a hybrid vehicle, an all-electric vehicle, or an internal combustion engine vehicle.

In the electric motor example, the powertrain 102 may include an inverter 109 which converts alternative current (AC) to direct current (DC) and vice versa. The inverter 109 may be electrically coupled to the energy storage device 108 and the prime mover 104 which is a traction motor, in such an example.

In the illustrated example, the transmission 106 delivers mechanical power to a differential 110 of an axle assembly 112 that includes drive wheels 114. The axle assembly 112 includes axle shafts 115 (e.g., half shafts) that rotationally couple the drive wheels 114 and the differential 110. Although other axle configurations are possible. Further, it will be appreciated that the transmission 106 may additionally or alternatively deliver mechanical power to the other axle 116 in the vehicle 100 and/or deliver mechanical power to the drive wheels via alternate or additional suitable components. Still further, in other examples, the transmission may be incorporated into one of the axles to form an electric axle assembly. In the electric axle example, an internal combustion engine may provide mechanical power to the other axle, in some cases.

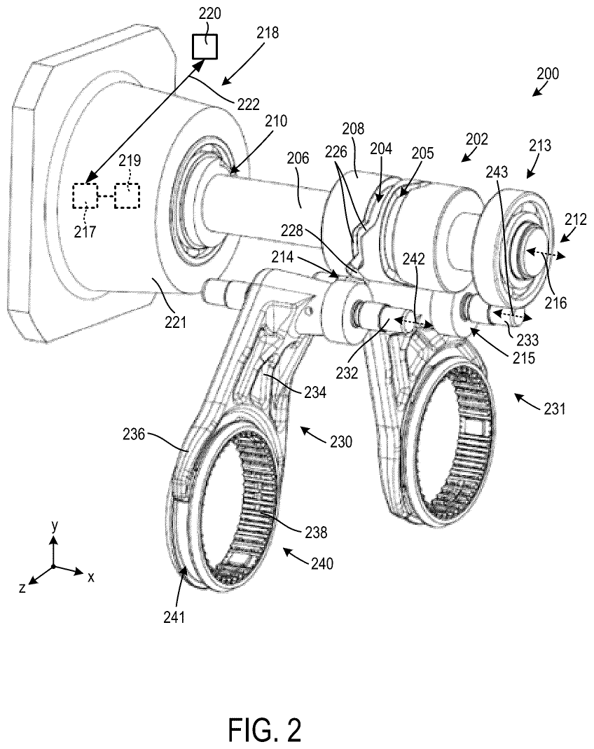

The transmission 106 (e.g., a gearbox) is rotationally coupled to the prime mover 104 via a shaft (e.g., a drive shaft) and/or other suitable mechanical component(s). The transmission 106 may include a barrel cam actuator assembly 118 that is designed with a targeted amount of axial compliance to reduce the chance of motor degradation when the clutches experience a blocked condition. The barrel cam actuator assembly 118 is schematically depicted in FIG. 1. However, it will be understood that the barrel cam actuator assembly 118 has greater structural complexity and the features of the assembly that provide the targeted amount of axial compliance are expanded upon herein with regard to FIGS. 2-13.

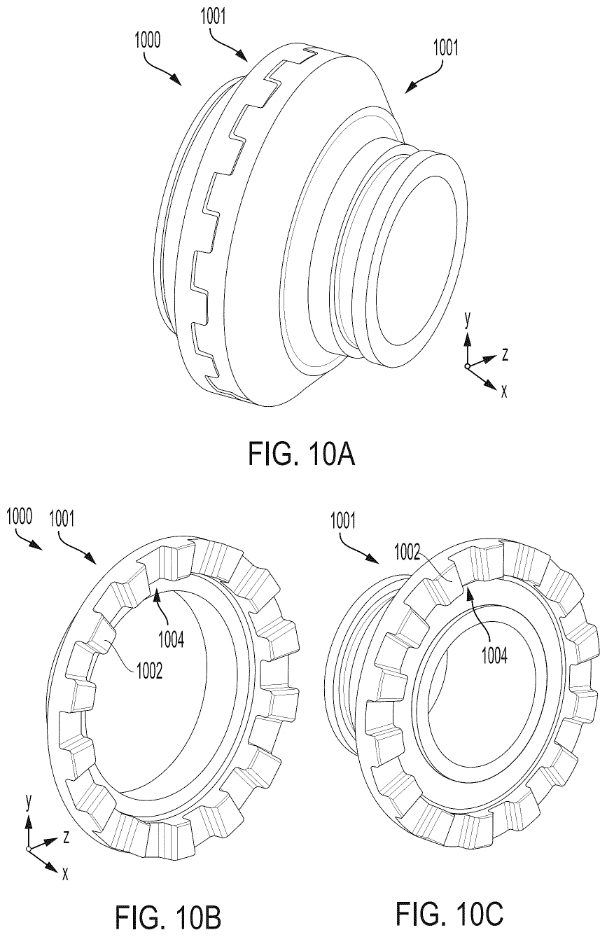

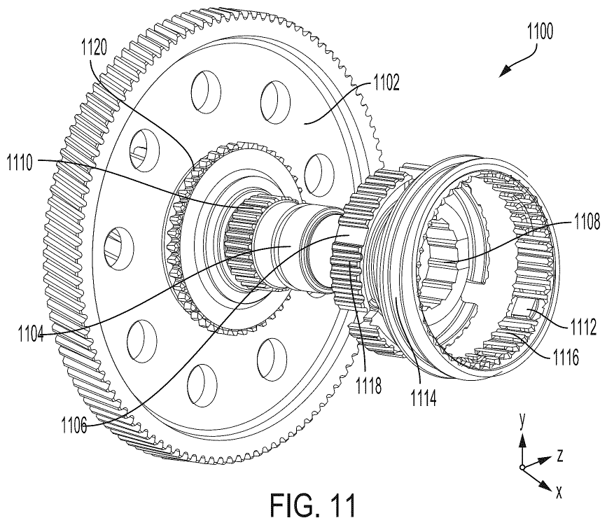

The barrel cam actuator assembly 118 includes a barrel cam and may include an actuation motor, a strain wave gearing device, one or more shift forks, and one or more cam followers, for instance. The shift forks are configured to engage and disengage one or more clutches 120. In turn, the clutches are configured to engage and disengage gears 122 to allow the transmission to shift between discrete operating gear ratios. For instance, to shift between gears, one clutch may be engaged and another clutch may be disengaged. One or more of the clutches 120 may specifically be dog clutches such as a face ring dog clutch where the toothed faces are on axial sides of two parts of the clutch. Further, in one example, one or more of the clutches may specifically be a dog clutch where the toothed faces are positioned on circumferential surfaces of the clutch sections. Examples of a face type dog clutch and another type of dog clutch are illustrated in FIGS. 10A-10C and FIG. 11 respectively and discussed in greater detail herein. Further, one or more of the clutches may be a synchronizer where friction elements (e.g., friction cones) are used to decrease the speed variance between the components in the clutch for smoother engagement.

During drive operation (e.g., forward drive or reverse drive operation) the mechanical power paths in the powertrain may flow from the prime mover 104 to the transmission 106, from the transmission to the differential 110, and from the differential to the drive wheels 114 via axle shafts 115 (e.g., half shafts).

A controller 150 (e.g., electronic control unit (ECU)) may form a portion of a control system 152. The controller may include memory 158 that is executable by a processor 160 to implement the methods, control strategies, and the like discussed herein. The control system 152 is shown receiving information from sensors 154 and sending control signals to actuators 156. As one example, the sensors 154 may include sensors such as a battery level sensor, clutch position sensors, an angular position sensor for the barrel cam, etc. As another example, the actuators 156 may include the barrel cam actuator assembly 118, etc. The shift fork actuator may be configured to move a clutch (e.g., a dog clutch or a synchronizer) into and out of engagement with one or more gears of the transmission 106. The controller 150 may receive input data from the sensors, process the input data via a processor, and trigger the actuators in response to the processed input data based on instruction or code programmed therein corresponding to one or more routines. In some examples, the controller 150 may include instructions that send a command signal to the barrel cam actuator assembly 118 to engage or disengage one of the clutches 120 which may in turn alter the operating gear ratio in the transmission. To elaborate, a control command may be sent to an actuation motor to rotate a barrel cam. The control techniques described herein may be stored as instructions in the controller 150 that are executable by the processor 160. As such, the control techniques, methods, and the like expanded upon herein may be stored as instructions in non-transitory memory. Input device(s) 161 (e.g., a gear selector, a drive mode selector, an accelerator pedal, a brake pedal, combinations thereof, and the like) may provide input to the controller that is indicative of an operator's intent for vehicle control.

FIG. 2 shows example of a barrel cam actuator assembly 200. The barrel cam actuator assembly 200 includes a barrel cam 202. In the illustrated example, the barrel cam 202 includes multiple tracks 204 and 205. However, it will be understood that the barrel cam 202 may include additional tracks or a single track, as discussed in greater detail herein.

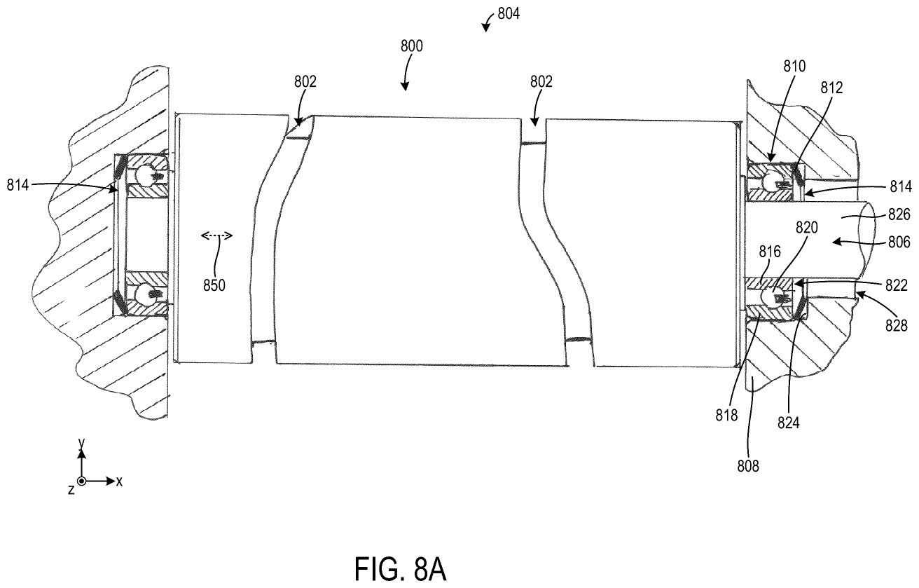

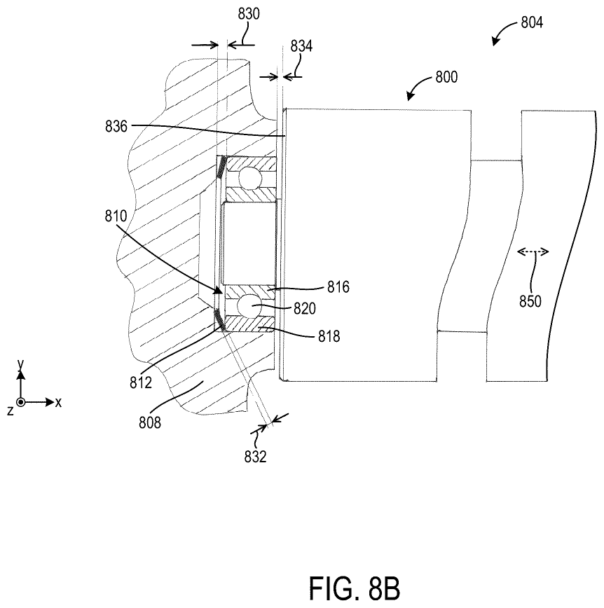

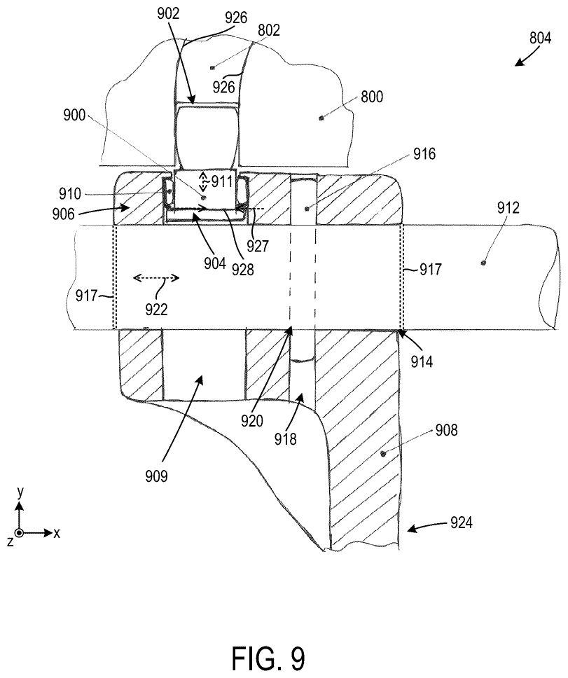

The barrel cam 202 includes a shaft 206 and a tracked body 208. The tracked body 208 includes the tracks 204 and 205. The shaft 206 includes a first end 210 and a second end 212. These ends may be rotatably coupled to a housing via one or more bearings 213 and springs to provide compliance (e.g., axial compliance) to the barrel cam 202. The bearings 213 may be ball bearings, in one example. Further, the springs may be cup springs, as discussed in greater detail herein. However, in other examples, the barrel cam may be rotationally and elastically coupled to a housing via a single spring and a single bearing or more than two springs and bearings. The compliant interface between the housing and the springs and bearing is expanded upon herein with regard to the example barrel cam actuator assembly depicted in FIGS. 8A-9.

The tracks 204 and 205 at least partially extends circumferentially around the barrel cam. Further, the tracks 204 and 205 is formed as a recess in the outer surface of the barrel cam. The profile (e.g., axial profile) of the track enables an axial position of cam followers 214 and 215 to be adjusted based on the rotational position of the barrel cam about an axis 216.

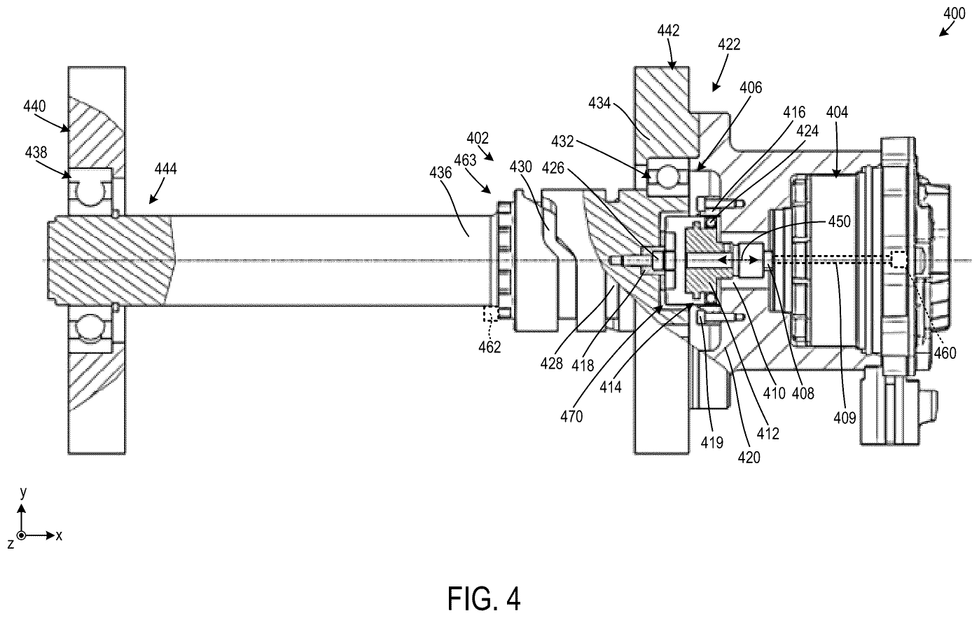

In the illustrated example, a sub-assembly 218 formed via an actuation motor 217 and a strain wave gearing device 219 is coupled to the barrel cam 202. To elaborate, the actuation motor 217 and the strain wave gearing device 219 may be incorporated into a housing 221 of the sub-assembly 218. The actuation motor 217 and the strain wave gearing device 219 are schematically depicted in FIG. 2. However, it will be understood that the actuation motor 217 and the strain wave gearing device 219 have greater structural complexity that is described in greater detail herein with regard to FIGS. 4-6. For instance, as discussed in greater detail herein, the strain wave gearing device 219 includes an outer spline, a flexible inner spline that meshes with the outer spline, and an elliptical wave generator.

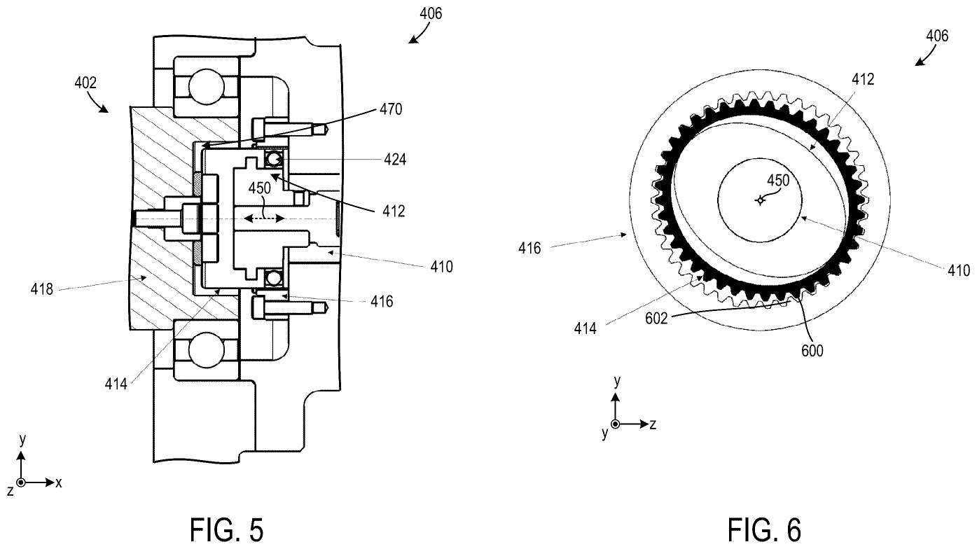

It will be understood that the actuation motor 217, shown in FIG. 2, includes a rotor and a stator that electromagnetically interact to induce rotation of a rotor shaft. Further, the actuation motor may be electrically coupled to a battery 220 and/or other suitable energy storage device (e.g., a capacitor, a flywheel, and the like). Arrow 222 indicates the electrical connection between the battery and/or other suitable energy storage device and the actuation motor 217. However, in an alternate example, other suitable actuator architectures that are configured to rotate the barrel cam may be used. The strain wave gearing device is described in greater detail herein with regard to FIGS. 5-6.

The strain wave gearing device 219 may be used to adjust barrel speed to motor speed and find a compromise between torque delivered at the barrel cam and shifting speed, in one example. In one use-case example, the actuation motor may have a top speed in the range 4000-5000 revolutions per minute (RPM) and a peak torque in the range 1-2 newton meters (Nm) and the drivetrain reduction ratio may be between 18 and 20. However, the motor may have a different top speed and/or peak torque in other examples. Further, the drivetrain reduction ratio may be within a different range, in alternate embodiments. The motor and drivetrain characteristics may be selected based on end-use design targets, the types of clutches used in the transmission, prime mover configuration, and the like.

The tracks 204 and 205 each include opposing walls 226 that axially capture ends 228 of the cam followers 214 and 215. The first ends 228 may have spherical shapes. Second ends of the cam followers 214 and 215 are mated with sections of shift forks 230 and 231. The second end may have a cylindrical shape. Designing the ends of the cam followers with spherical and cylindrical shapes allows enhanced contact between the cam follower and the shift forks 230 and 231 even when shift fork rods 232 and 233 is bending. The second end of the cam followers 214 and 215 may be coupled to the shift forks 230 and 231 via bearings (e.g., a needle roller bearing) which is discussed in greater detail herein.

The shift forks 230 and 231 each includes a body 234 in the illustrated example. Further, in the illustrated example, the shift forks 230 and 231 each includes prongs 236 (e.g., circumferentially shaped prongs) that extend from the bodies 234 and interface with portions 238 of clutches 240. The portions 238 of the clutches are illustrated as shift sleeves which may be included in synchronizers that may include a synchronizer rings which allows the clutches to be more smoothly engaged. Alternatively, the clutches 240 may be a dog clutches which include splines and/or toothed faces that engage one another without speed synchronization functionality.

The shift sleeve includes a circumferential recess 241 that mates with the prongs 236. However, the clutches may be face dog ring style clutches, in other examples. Central axes 242 and 243 of the shift fork rods 232 is further depicted in FIG. 2 for reference. The actuator assembly allows multiple clutches to be more efficiently actuated using a single barrel cam actuator when compared to other systems that make use of a dedicated actuator (e.g., a hydraulic piston) is for each gearshift device (i.e., in case of hydraulic pistons). Using one actuator assembly for multiple clutches also allows a single angular position sensor (e.g., a rotary sensor) to be used for determination of the position of both shift forks.

FIG. 4 shows a first example location for an angular position sensor 460 (e.g., absolute encoder) where it is coupled to an end of the rotor shaft 409 that is opposite from the end of the rotor shaft which is coupled to a strain wave gearing device 406, discussed in greater detail herein. To elaborate, the angular position sensor 460 may be an absolute encoder located on an end of the electric motor shaft that is not coupled to the strain wave gearing 406. Alternatively, an angular position sensor 462 (which may be in the form of an absolute encoder) may be coupled to an end 463 of the barrel cam 402 that opposite to the end of the barrel cam which is coupled to the strain wave gearing device 406.

Further, the multiple track barrel cam 202 may provide interlocking capability since the plurality of forks are compelled in a known position dictated by the tracks profile. Barrel cams may have a bulky profile if they operate a single fork but this is mitigated adding multiple shift forks so that a single actuator can accomplish multiple functions with regard to clutch actuation. In one use-case example, the barrel cam may have a 65 millimeters (mm) outside diameter. However, a variety of suitable barrel cam sizes have been contemplated.

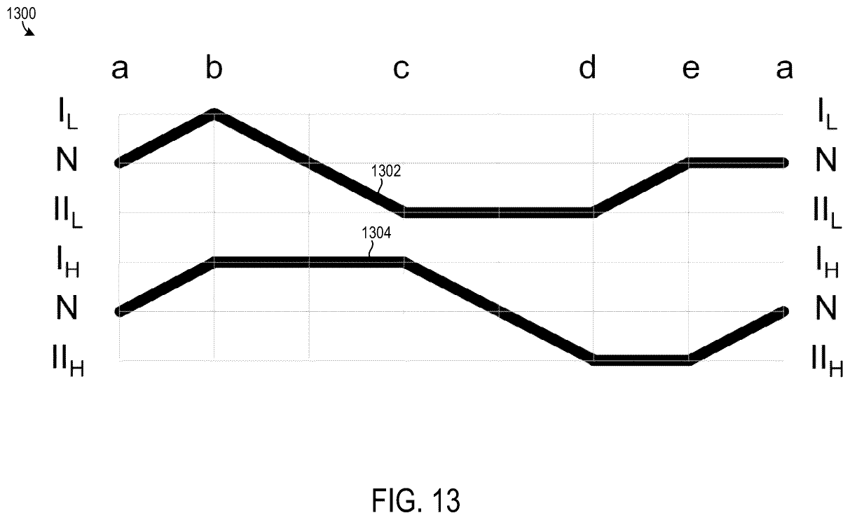

FIG. 13 shows an exemplary flat pattern layout 1300 for a barrel cam with two tracks. The pattern may be exhibited in the barrel cam 200 shown in FIG. 2 as well as the other multi-track barrel cams described herein. However, the barrel cams may have other suitable track patterns, in alternate examples. Positions a, b, c, d, and e denote different rotational positions of the barrel cam. I_{L}, N, and II_{L} denote the position of a first clutch that corresponds to the track 1302. I_{H}, N, and II_{H} denote the positions of a second clutch that corresponds to the track 1304. Thus, each of the associated clutches have two engaged positions and one neutral position, in the illustrated example. However, clutches with a fewer or greater number of positions may be used in other examples. Please note that in the illustrated example, there are seven possible states for the barrel cam. To elaborate, there are seven possible states of the barrel cam, in the illustrated examples and the left-hand side and right-hand side of the curves coincides to have a continuous track in the barrel so that each actuation demanded for a barrel rotation of 2π/7 radians. However, as previously discussed other track profiles are possible.

Further, in the example illustrated in FIG. 13, whenever a fork is moving (e.g., position d to e, upper sloping line) the other is steady (lower horizontal track). However, in the illustrated example, this does not apply to the transition from position a to b. Further, in the illustrated example, position a is a true neutral state of the transmission and may be used during towing, for example. It will be understood, that the flat pattern layout is exemplary in nature and the barrel cam may have many different track patterns whose layout may be determined based on the transmission architecture, shifting performance, end-use design goals, and the like, for example.

FIGS. 2-12 include a coordinate system to orient the views, when appropriate. The y-axis may be a vertical axis (e.g., parallel to a gravitational axis), the x-axis may be a longitudinal axis (e.g., horizontal axis), and/or the z-axis may be a lateral axis, in one example. However, the axes may have other orientations, in other examples.

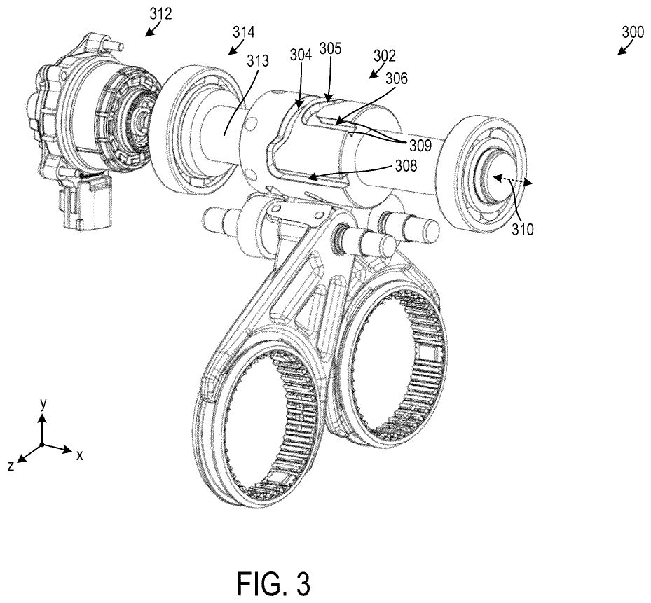

FIG. 3 shows another example of a barrel cam actuator assembly 300. The barrel cam actuator assembly 300 includes a barrel cam 302. The barrel cam actuator assembly 300 includes structural and function features that overlap with the barrel cam actuator assembly 200, shown in FIG. 2. Therefore, redundant description of the overlapping structural and functional features is omitted for brevity. Further, it will be understood, that any of the features of the barrel cam actuator assemblies shown in FIGS. 2-3 as well as the other cam actuator assemblies described herein may be combined to form additional assembly variants to achieve synergistic effects of combining the features.

In the illustrated example, the barrel cam 302 includes multiple tracks 304 and 305, similar to the barrel cam 202 shown in FIG. 2. However, as shown in FIG. 3, the tracks 304 and 305 each include an axially aligned section 306 and 308. That is to say, the axially aligned sections 306 and 308 are parallel to one another and a central axis 310 of the barrel cam 302. The axially aligned section 306 and 308 allow the barrel cam actuator assembly 300 to be inserted into the transmission as a cartridge, thereby increasing efficiency with regard to manufacturing, servicing, and repair. The axially aligned sections each include opposing walls 309 in the illustrated example.

In the example shown in FIG. 3, the barrel cam actuator assembly 300 further includes an electric motor 312 rotationally coupled to a shaft 313 of the barrel cam 302 and a bearing 314.

FIG. 4 shows yet another example of a barrel cam actuator assembly 400. Portions 442 and 444 of the barrel cam actuator assembly 400 are shown in cross-section to reveal internal componentry that is described in greater detail herein. The barrel cam actuator assembly 400 includes a barrel cam 402. The barrel cam actuator assembly 400 includes structural and function features that overlap with the barrel cam actuator assembly 200, shown in FIG. 2.

The barrel cam actuator assembly 400 further includes an electric motor 404 that is rotationally coupled to the strain wave gearing device 406 (which is an example of the strain wave gearing device 219 that is schematically depicted in FIG. 2). To elaborate, as illustrated in FIG. 4, an output shaft 408 (which is couple to or formed with a rotor shaft 409 of the motor) is rotationally coupled to an input shaft 410 of the strain wave gearing device 406. The input shaft 410 is rotationally coupled to an elliptical wave generator 412 (e.g., an elliptical plug). Rotation of the elliptical wave generator 412 forces a flexible inner spline 414 (e.g., flexible inner gear) to mesh with an outer spline 416 (e.g., a rigid gear with internal teeth that have a circular profile). The flexible inner spline 414 has less teeth (and therefore a smaller diameter than the gear 416) to allow the strain wave gearing device 406 to achieve its gear reduction functionality. To expound, the strain wave gearing device 406 realizes a reduction ratio defined by the difference between the number of teeth of the gear 416 and the number of teeth of the flexible inner spline 414 divided by the number of teeth of the gear 416. The strain wave gearing device 406 achieves increased compactness (when compared to other types of gear reductions such as planetary gear sets, for instance) and the absence of backlash.

In the illustrated example, the barrel cam 402 includes a hollow interior section 470 that at least partially encloses the flexible inner spline 414. In this way, the compactness of the actuation system is increased, enabling the system to be more effectively incorporated into a wider variety of transmissions. However, barrel cams with outer contours may be used in the actuation system.

Further, the strain wave gearing device 406 has an output shaft 418 that is coaxial to the input shaft 410. Attachment device 419 may be used to attach the strain wave gearing device 406 (and specifically the gear 416) to a section 420 of a housing 422. Further, a bearing 424 in the strain wave gearing device 406 may be coupled to the plug 412 to permit rotation thereof and support the plug.

An attachment device 426 and/or other suitable device, mechanism, etc. may be used to rotationally attach the strain wave gearing device 406 to the barrel cam 402. The barrel cam 402 again includes a first track 428 and a second track 430. A bearing 432 may be coupled to the barrel cam 402 and incorporated into a section 434 of the housing 422. A shaft 436 (which may be coupled to or integrally formed with the barrel cam) may axially extend away from the barrel cam body and have a bearing 438 coupled thereto. As described herein a bearing may include an inner race, roller elements (e.g., balls, cylindrical rollers, needle rollers, etc.), and an outer race. However, at least some of the bearings may be formed as bushings. The bearing 438 may be incorporated into a housing section 440. A rotational axis 450 of the strain wave gearing device 406 is provided in FIGS. 4 and 5-6 for reference. As previously discussed, the input and output shafts of the strain wave gearing device are coaxially arranged, thereby increasing device compactness.

FIG. 5 shows a detailed cross-sectional view of the strain wave gearing device 406. The input shaft 410, the elliptical wave generator 412, the flexible inner spline 414, the outer spline 416, and the output shaft 418 are again illustrated in FIG. 5. FIG. 5 further illustrates the hollow interior section 470 that at least partially encloses the flexible inner spline 414.

FIG. 6 shows yet another cross-sectional view of the strain wave gearing device 406. The input shaft 410, the elliptical wave generator 412, the flexible inner spline 414, and the outer spline 416 are again illustrated. Outer teeth 600 of the flexible inner spline 414 that mesh with inner teeth 602 of the outer spline 416.

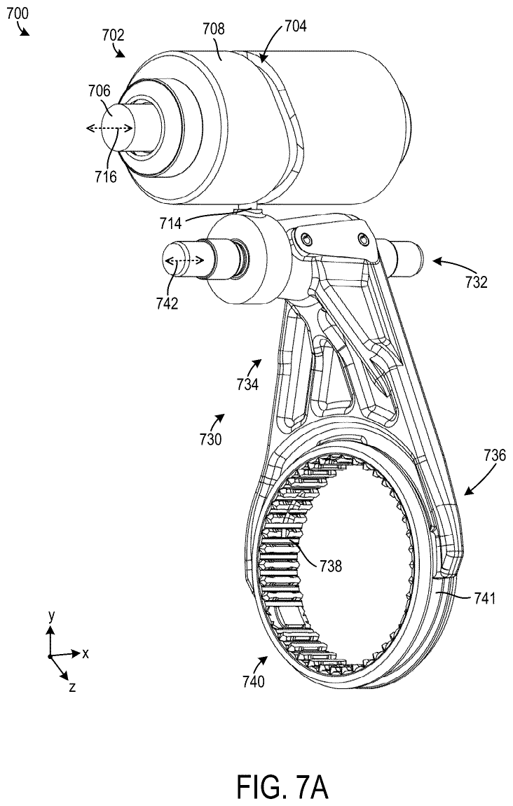

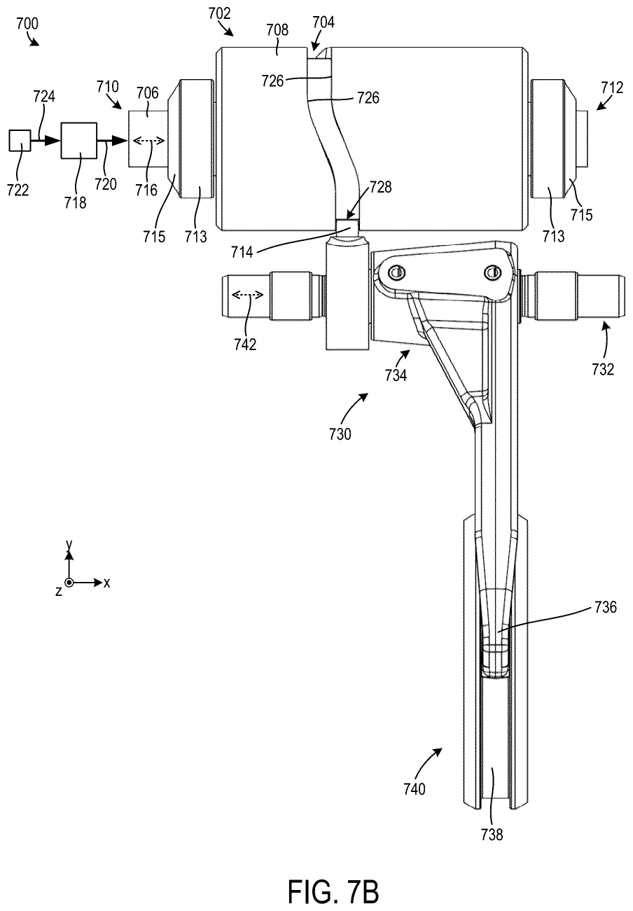

FIGS. 7A-7B show an example of a barrel cam actuator assembly 700. It will be appreciated that at least a portion of the structural and/or functional features from one or more of the barrel cam actuator assemblies described herein or combinations of the assemblies may be incorporated into the barrel cam actuator assembly 700, depicted in FIG. 7. The barrel cam actuator assembly 700 includes a barrel cam 702. In the illustrated example, the barrel cam 702 includes one track 704. However, it will be understood that the barrel cam 702 may include additional tracks.

The barrel cam 702 includes a shaft 706 and a tracked body 708. The tracked body 708 includes the track 704. The shaft 706 includes a first end 710 and a second end 712. These ends may be rotatably coupled to a housing via bearings 713 and springs 715 to provide compliance (e.g., axial compliance) to the barrel cam 702. The bearings 713 may be ball bearings, in one example. Further, the springs 715 may be cup springs. However, in other examples, the barrel cam may be rotationally and elastically coupled to a housing via a single spring and a single bearing or more than two springs and bearings. The compliant interface between the housing and the springs and bearing is expanded upon herein.

The track 704 at least partially extends circumferentially around the barrel cam. Further, the track 704 is formed as a recess in the outer surface of the barrel cam. The profile (e.g., axial profile) of the track enables an axial position of a cam follower 714 to be adjusted based on the rotational position of the barrel cam about an axis 716.

In the illustrated example, an actuation motor 718 which is schematically depicted in FIGS. 7A-7B is coupled to the barrel cam 702. Arrow 720 indicates the mechanical connection between the actuation motor 718 and the barrel cam 702. The actuation motor 718 includes a rotor and a stator that electromagnetically interact to induce rotation of a rotor shaft. Further, the actuation motor 718 may be electrically coupled to a battery 722 and/or another suitable energy storage device (e.g., a capacitor, a flywheel, combinations thereof, and the like). Arrow 724 indicates the electrical connection between the battery and/or other suitable energy storage device and the actuation motor 718. However, in an alternate example, other suitable actuators that are configured to rotate the barrel cam may be used.

A strain wave gearing device may be used to adjust barrel speed to motor speed and find a compromise between torque delivered at the barrel cam and shifting speed, in one example. In one use-case example, the actuation motor may have a top speed in the range 4000-5000 revolutions per minute (RPM) and a peak torque in the range 1-2 newton meters (Nm) and the drivetrain reduction ratio may be between 18 and 20. However, the motor may have a different top speed and/or peak torque in other examples. Further, the drivetrain reduction ratio may be within a different range, in alternate embodiments. The motor and drivetrain characteristics may be selected based on end-use design targets, the types of clutches used in the transmission, prime mover configuration, and the like.

The track 704 includes opposing walls 726 that axially capture a first end 728 of the cam follower 714. The first end 728 may have a spherical shape. A second end of the cam follower 714 is mated with a section of a shift fork 730. The second end may have a cylindrical shape. Designing the ends of the cam follower with spherical and cylindrical shapes allows enhanced contact between the cam follower and the shift fork 730 even when a shift fork rod 732 is bending. The second end of the cam follower 714 may be coupled to the shift fork 730 via a bearing (e.g., a needle roller bearing) which is discussed in greater detail herein with regard to FIG. 9.

The shift fork 730 includes a body 734 in the illustrated example. Further, in the illustrated example, the shift fork 730 includes prongs 736 (e.g., circumferentially shaped prongs) that extend from the body 734 and interface with a portion 738 of a clutch 740. The portion 738 of the clutch is illustrated as a shift sleeve which may be included in a synchronizer. The shift sleeve includes a circumferential recess 741 that mates with the prongs 736. However, the clutch may be a face dog ring style clutch, in other examples. A central axis 742 of the shift fork rod 732 is further depicted in FIGS. 7A-7B for reference.

FIG. 8A shows yet another example of a barrel cam 800 with multiple tracks 802. When installed in the actuator assembly, each of the tracks mates with a cam follower which is coupled to a shift fork to facilitate axial translation of the shift fork. The profiles of the tracks 802 may be designed to actuate clutches associated with the shift forks at desired time intervals. For instance, the tracks may be profiled to engage one clutch while disengaging another clutch. However, in alternate examples, the tracks may be profiled to engage one clutch while the remaining clutches are sustained in disengaged states. The profiles of the tracks may be selected based on desired shifting characteristics in the transmission.

The barrel cam 800 may include one or more detents, in another example. To elaborate, in such an example, the detents are configured to maintain the barrel cam in a stable position. To accomplish this functionality, balls which are preloaded via springs may be mated with the detents. In this way, the barrel cam may be maintained at rest. However, in other examples, the detents, balls, and springs may be omitted from the actuator assembly.

The barrel cam 800 and associated components are included in a barrel cam actuator assembly 804. The barrel cam 800 includes a shaft 806 which is mounted in a housing 808 (e.g., transmission housing) via a pair of bearings 810 and a pair of springs 812 at opposing axial sides 814. In another example, a single bearing and a single spring may be used in the actuator assembly to rotationally attach the barrel cam to the housing. In another alternate example, more than two springs and bearings may be used in the actuator assembly to rotationally attach the barrel cam to the housing.

Each of the bearings 810 includes an inner race 816 that interfaces with the shaft 806 and an outer race 818 that interfaces with the housing 808. To elaborate, the inner races 816 may be interference fit with the shaft 806 and the outer races 818 may be sliding fit with the housing to allow the barrel cam 800 to move axially. Roller elements 820 which are depicted as balls in the illustrated example are positioned between the inner and outer races. In other examples, the roller elements in the bearings may be tapered rollers.

Each of the springs 812 are positioned between an outboard axial side 822 of the associated bearing and a wall 824 of the housing 808. The springs 812 are specifically depicted as cup springs which allow the space efficiency of the assembly to be increased. However, other suitable types of springs may be used in the actuator assembly in other examples, such as coil springs, wave springs, combinations thereof, and the like. Using coil springs may however decrease the assembly's space efficiency.

A section 826 of the shaft 806 is rotationally coupled to an actuation motor or other suitable rotational actuator. An opening 828 in the housing 808 allows the shaft section 826 to pass therethrough. The diameter of the opening 828 may be smaller than an inner diameter of the spring 812.

The springs 812 may be substantially equivalently preloaded such that they counteract one another. The preload may be in a direction that is parallel to a central axis 850 of the barrel cam 800. The balance of the spring preloads results in a nominal position of the barrel cam. In this way, the barrel cam is able to exhibit desired axial compliance characteristics.

FIG. 8B shows a detailed view of the barrel cam 800, the bearing 810, and the spring 812 which are included in the barrel cam actuator assembly 804. The spring housing and the spring thickness may be selected based on a desired maximum stroke of barrel cam. An axial clearance 830 between the bearing 810 and a side surface of the housing 808 is shown in FIG. 8B. The thickness 832 of the spring 812 is also shown in FIG. 8B. It will be understood that the maximum stroke of the barrel cam 800 may be the axial clearance 830 minus the spring thickness 832. The central axis 850 of the barrel cam 800 is again depicted in FIG. 8B.

In one specific use-case example, the maximum stroke may be in the range 0.6-0.8 millimeters (mm). However, numerous maximum stroke ranges are possible. More generally, the maximum stroke of the barrel cam may be smaller than a gap 834 between the barrel flank 836 and the housing 808. In case of face-to-face event, the resulting force will be transmitted by the cam follower to the barrel that will shift axially. Before reaching the end of stroke condition, the spring 812 may apply a load nearly proportional to the stroke itself, accumulating the power from the electric motor thus preventing its stall. When the favorable engaging condition is restored, the spring 812 provides the energy to complete the engagement. Upon reaching the end of stroke the spring 812 is flat and the barrel cam reaches a hard stop. The spring 812 may be designed as a cup spring for this reason. In the embodiment where the barrel cam includes multiple tracks, the maximum stroke is such that the resting forks (associated with a portion of the tracks) are not moved from their position, preventing unwanted engagement and disengagement. A resting fork denotes that a desired configuration of the fork during the range of barrel cam rotation remains unchanged. For instance, the resting shift fork allows the associated clutch to be sustained in a disengaged or engaged configuration. When the barrel cam reaches the hard stop the motor may stall. However, it will be understood the favorable engagement event for the clutch is more likely to happen before reaching the end of stroke in the barrel cam actuator assembly 804. The inner race 816, the roller elements 820, and the outer race 818 are again depicted in FIG. 8B.

FIG. 9 shows a cross-sectional view of the barrel cam actuator assembly 804. The barrel cam 800 with the tracks 802 are again depicted. In the illustrated example, the barrel cam actuator assembly 804 further includes a cam follower 900 with a first end 902 that is mated with the one of the tracks 802 and a second end 904 that is mated with a section 906 (e.g., a body) of a shift fork 908. The first end 902 may be spherically shaped to enable smooth interaction between the barrel cam 800 and the cam follower 900.

The second end 904 of the cam follower 900 may be cylindrically shaped to function as an inner race of a bearing 910 which may at least circumferentially surround the cam follower 900. The bearing 910 and the cam follower 900 are positioned in an opening 909 in the shift fork 908. Further, a rotational axis 911 of the bearing 910 is provided for reference. The axis 911 may be perpendicular to the axis 922. However, other bearing configurations are possible.

The bearing 910 may specifically be a needle roller bearing to increase the assembly's space efficiency. However, other types of bearings may be used which may however increase the size of the system. Further, in another embodiment, another bearing (e.g., needle roller bearing) may be position on the opposing axial side of the cam follower 900 as the bearing 910.

In the illustrated example, a rod 912 extends through an opening 914 in the shift fork 908. To elaborate, the rod 912 may be sliding fit to the body of the shift fork 908 to enhance system assembly. For instance, the rod 912 may be slidingly coupled to the housing 808, shown in FIG. 8B, via bushings and/or other suitable components. However, other system configurations are possible. The rod 912 may be compliantly coupled to the shift fork 908 via a compliant pin 916. To elaborate, the compliant pin 916 may extend through openings 918 in the shift fork 908 and a bore 920 in the rod 912. The compliant pin 916 may have a substantially constant diameter along its length in one example. Further, the compliant pin 916 may be perpendicularly arranged with regard to a central axis 922 of the rod 912. Alternatively, circlips 917 may be used to attach the rod 912 to the shift fork 908. Still further in other examples, the pin and the circlips may be omitted from the assembly and the shift fork may be slidingly coupled to the rod. Even further in another example, the rod may be coupled to the shift fork via a circlip and an abutment. Still further in another example, the shift fork and the rod may be formed as an integrated component. The shift fork 908 includes a clutch interface 924 that may be in the form of fork arms that mate with a recess in a clutch.

In one use-case example, the diameter of the barrel cam may be greater than 65 mm, the track may be 8-10 mm wide and 6-7 mm deep. Further, the stroke from a neutral state to an engaged state may be 9 mm. However, barrel cams with a wide variety of dimensions that may or may not be with these ranges may be utilized, in other embodiments.

In one specific use-case example, the clearance between the end 902 of the cam follower 900 and the track sides 926 may be in the range 0.05-0.1 mm. In such an example, a radius 927 of the tip 928 of the cam follower 900 may be in the range of 25-30 mm. Designing the cam follower with these dimensions enable unwanted hysteresis to be avoided, in some cases. However, it will be appreciated that the cam follower may have a variety of dimensions, in alternate embodiments, which may also be capable of decreasing the chance of undesirable hysteresis.

It will be appreciated that the other tracks in the barrel cam 800, which are obscured from view in FIG. 9, may be similarly attached to other shift forks via cam followers which mate with the track and are attached to the associated shift fork via a bearing (e.g., a needle roller bearing).

FIGS. 10A-10C show an example of a dog clutch 1000. To elaborate, the dog clutch is in the form of a face type dog clutch with two sections 1001 which each include teeth 1002 on faces 1004 of the clutch sections. The teeth engage and disengage to permit and inhibit torque transfer through the clutch. The dog clutch 1000 may be engaged and disengaged by any of the barrel cam actuator assemblies described herein.

FIG. 11 shows an example of a dog clutch 1100 (e.g., a dog clutch with a tipped end to facilitate engagement) where the gear 1102 can rotate on the shaft 1104 being separated by a needle roller bearing. In the illustrated example, the hub 1106 has an inner spline 1108 that may be permanently mated with the spline 1110 so that the hub is rotatably connected to the shaft. The hub may also be axially fixed to the shaft by a couple of circlips. Further, in the illustrated example, the sleeve 1112 is rotatably connected to the hub by the spline pairs 1116 and 1118 can slide on it. A shift fork will drive axially the sleeve 1112 by means of the groove 1114. When the sleeve is forced towards the gear the spline 1116 will couple with both the splines 1120 and 1118 thus rotatably connecting the gear and the shaft. The dog clutch 1100 shown in FIG. 11 does not include friction cones. However, other types of clutches have been contemplated such a synchronizer which makes use of friction cones. The dog clutch 1100 may be engaged and disengaged by any of the barrel cam actuator assemblies described herein.

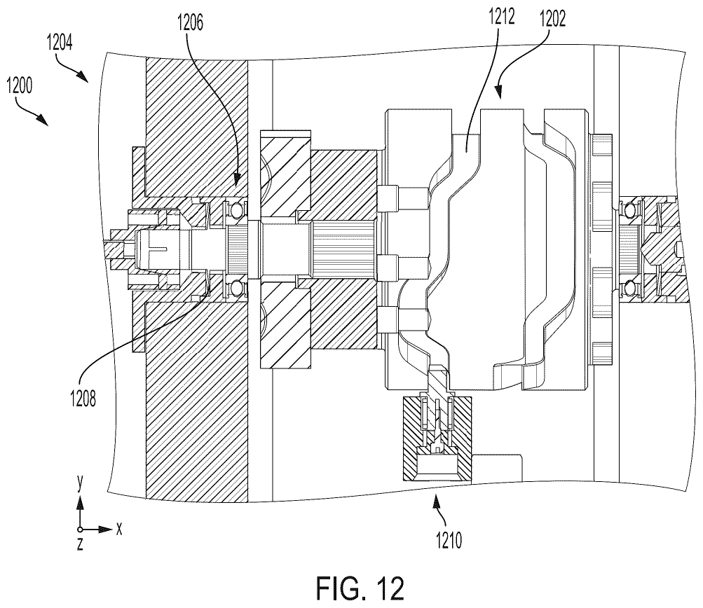

FIG. 12 shows another example of a barrel cam actuator assembly 1200 with a barrel cam 1202 that is elastically and rotatably mounted in a housing 1204 via bearings 1206 and springs 1208 (e.g., cup springs). The barrel cam actuator assembly 1200 further includes a cam follower 1210, in the illustrated example. The cam follower 1210 interfaces with one of the tracks 1212 in the barrel cam 1202. The barrel cam actuator assembly 1200 may share overlapping structural and functional characteristics with the other actuator assemblies described herein and vice versa. Therefore, redundant description of these overlapping features is omitted for brevity.

FIGS. 1-13 provide for a method of operation of a barrel cam actuator assembly. The method includes rotating a barrel cam based on a shift condition. The shift condition may be an operator's request to change gear based on an interaction with a gear shift interface or an automatic shift condition which is generated based on a change in vehicle speed and/or load. In one example, rotating the barrel cam includes energizing an actuation motor which is rotationally coupled to the barrel cam. As indicated above, the method may be implemented by a controller (e.g., ECU) in conjunction with any of the barrel cam actuator assemblies described herein or combinations of the barrel cam actuator assemblies. However, in other examples, the method may be carried out via other suitable barrel cam actuator assemblies. The method may additionally or alternatively include adjusting a rotational position of a barrel cam through operation of an electric motor based on a barrel cam position signal that is generated by an angular position sensor. Further, the method may additional or alternatively include adjusting the barrel cam includes adjusting the rotational position of the barrel cam to selectively engage a first clutch and a second clutch at different times.

Further, the powertrains and transmissions described herein may include control systems that include a controller with a processor and memory that stores instructions for carrying out the method steps described herein. To elaborate, the control methods and routines disclosed herein may be stored as executable instructions in non-transitory memory and may be carried out by a system including the controller in combination with the various sensors and actuators. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for case of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in a system including the various hardware components in combination with the electronic controller. One or more of the method steps described herein may be omitted if desired.

FIGS. 2-12 are drawn approximately to scale, although alternate component dimensions may be used in other embodiments. FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The invention will be further described in the following paragraphs. In one aspect, a barrel cam actuator assembly is provided that comprises a barrel cam including a first track; a strain wave gearing device that is arranged coaxial to the barrel cam and rotationally coupled to the barrel cam; and an electric motor rotationally coupled to the strain wave gearing device and configured to selectively rotate the strain wave gearing device; wherein the strain wave gearing device includes an outer spline, a flexible inner spline that meshes with the outer spline, and an elliptical wave generator. Further, in one example, the barrel cam may include a hollow interior section; and at least a portion of a flexible inner spline of the strain wave gearing device may be positioned within the hollow interior section. Further, in one example, the barrel cam may include a second track and the barrel cam actuator assembly may further comprise a first cam follower and a second cam follower mated with the first track and the second track. In yet another example, the barrel cam may include a second track; and the first track and the second track may each include a section that axially extends along a periphery of the barrel cam. In one example, the barrel cam actuator assembly may further comprise an angular position sensor coupled to the barrel cam and configured to send data indicative of barrel cam position to a controller. In one example, the barrel cam actuator assembly may further comprise a housing enclosing a portion of the barrel cam and the strain wave gearing device. In one example, the barrel cam actuator assembly may further comprise a shift fork coupled to a rod via a compliant pin, coupled to the rod via a circlip, or slidingly coupled to the rod. In one example, the barrel cam actuator assembly may further comprise a cam follower including a first end positioned within one track and a second end positioned within the shift fork via a bearing. Even further in one example, the bearing may be a needle roller bearing. Still further in one example, the shift fork may be coupled to a dog clutch or a synchronizer. In one example, the barrel cam actuator assembly may further comprise a pair of spring positioned on opposing axial sides of the barrel cam. In yet another example, the pair of springs may be cup springs. In another example, a gear ratio of the strain wave gearing device may be greater than or equal to 50:1.

In another aspect, a method for operation of a barrel cam actuator assembly is provided that comprises adjusting a rotational position of a barrel cam through operation of an electric motor based on a barrel cam position signal that is generated by an angular position sensor; wherein the barrel cam actuator assembly includes: the barrel cam with a first track; a strain wave gearing device that is arranged coaxial to the barrel cam and rotationally coupled to the barrel cam; and the electric motor rotationally coupled to the strain wave gearing device and configured to selectively rotate the strain wave gearing device; wherein the strain wave gearing device includes an outer spline, a flexible inner spline that meshes with the outer spline, and an elliptical wave generator. In one example, the barrel cam may include a second track; and adjusting the barrel cam may include adjusting the rotational position of the barrel cam to selectively engage a first clutch and a second clutch at different times.

In another aspect, a barrel cam actuator assembly is provided that comprises a barrel cam including a first track; a strain wave gearing device that is arranged coaxial to the barrel cam and rotationally coupled to the barrel cam; and an electric motor rotationally coupled to the strain wave gearing device and configured to selectively rotate the strain wave gearing device; wherein the strain wave gearing device includes an outer spline, a flexible inner spline that meshes with the outer spline, and an elliptical wave generator rotationally coupled to an input shaft and cyclically flexing the flexible inner spline via rotation. In one example, the barrel cam actuator assembly may further comprise a first cam follower and a second cam follower mated with the first track and a second track in the barrel cam, wherein the first track and the second track each include a section that axially extends along a periphery of the barrel cam. In yet another example, the barrel cam actuator assembly may further comprise a first shift fork coupled to the first cam follower; and a second shift fork coupled to the second cam follower. In another example, the first shift fork and the second shift fork may be coupled to a first clutch and a second clutch, respectively, the barrel cam may include a hollow interior section; and at least a portion of the flexible inner spline of the strain wave gearing device may be positioned within the hollow interior section. In another example, the first clutch and the second clutch may be synchronizers.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A barrel cam actuator assembly, comprising:
a barrel cam including a first track;
a strain wave gearing device that is arranged coaxial to the barrel cam and rotationally coupled to the barrel cam; and
an electric motor rotationally coupled to the strain wave gearing device and configured to selectively rotate the strain wave gearing device;
wherein the strain wave gearing device includes an outer spline, a flexible inner spline that meshes with the outer spline, and an elliptical wave generator.

2. The barrel cam actuator assembly of claim 1, wherein:
the barrel cam includes a hollow interior section; and
at least a portion of a flexible inner spline of the strain wave gearing device is positioned within the hollow interior section.

3. The barrel cam actuator assembly of claim 1, wherein the barrel cam includes a second track and the barrel cam actuator assembly further comprises a first cam follower and a second cam follower mated with the first track and the second track.

4. The barrel cam actuator assembly of claim 1, wherein:
the barrel cam includes a second track; and
the first track and the second track each include a section that axially extends along a periphery of the barrel cam.

5. The barrel cam actuator assembly of claim 1, further comprising an angular position sensor coupled to the barrel cam and configured to send data indicative of barrel cam position to a controller.

6. The barrel cam actuator assembly of claim 1, further comprising a housing enclosing a portion of the barrel cam and the strain wave gearing device.

7. The barrel cam actuator assembly of claim 1, further comprising a shift fork coupled to a rod via a compliant pin, coupled to the rod via a circlip, or slidingly coupled to the rod.

8. The barrel cam actuator assembly of claim 7, further comprising a cam follower including a first end positioned within one track and a second end positioned within the shift fork via a bearing.

9. The barrel cam actuator assembly of claim 8, wherein the bearing is a needle roller bearing.

10. The barrel cam actuator assembly of claim 8, wherein the shift fork is coupled to a dog clutch or a synchronizer.

11. The barrel cam actuator assembly of claim 1, further comprising:
a pair of spring positioned on opposing axial sides of the barrel cam.

12. The barrel cam actuator assembly of claim 11, wherein the pair of springs are cup springs.

13. The barrel cam actuator assembly of claim 1, wherein a gear ratio of the strain wave gearing device is greater than or equal to 50:1.

14. A method for operation of a barrel cam actuator assembly, comprising:
adjusting a rotational position of a barrel cam through operation of an electric motor based on a barrel cam position signal that is generated by an angular position sensor;
wherein the barrel cam actuator assembly includes:
the barrel cam with a first track;
a strain wave gearing device that is arranged coaxial to the barrel cam and rotationally coupled to the barrel cam; and
the electric motor rotationally coupled to the strain wave gearing device and configured to selectively rotate the strain wave gearing device;
wherein the strain wave gearing device includes an outer spline, a flexible inner spline that meshes with the outer spline, and an elliptical wave generator.

15. The method of claim 14, wherein:
the barrel cam includes a second track; and
adjusting the barrel cam includes adjusting the rotational position of the barrel cam to selectively engage a first clutch and a second clutch at different times.

16. A barrel cam actuator assembly, comprising:
a barrel cam including a first track;
a strain wave gearing device that is arranged coaxial to the barrel cam and rotationally coupled to the barrel cam; and
an electric motor rotationally coupled to the strain wave gearing device and configured to selectively rotate the strain wave gearing device;
wherein the strain wave gearing device includes an outer spline, a flexible inner spline that meshes with the outer spline, and an elliptical wave generator rotationally coupled to an input shaft and cyclically flexing the flexible inner spline via rotation.

17. The barrel cam actuator assembly of claim 16, further comprising a first cam follower and a second cam follower mated with the first track and a second track in the barrel cam, wherein the first track and the second track each include a section that axially extends along a periphery of the barrel cam.

18. The barrel cam actuator assembly of claim 17, further comprising:
a first shift fork coupled to the first cam follower; and
a second shift fork coupled to the second cam follower.

19. The barrel cam actuator assembly of claim 18, wherein:
the first shift fork and the second shift fork are coupled to a first clutch and a second clutch, respectively;
the barrel cam includes a hollow interior section; and
at least a portion of the flexible inner spline of the strain wave gearing device is positioned within the hollow interior section.

20. The barrel cam actuator assembly of claim 19, wherein the first clutch and the second clutch are synchronizers.
